(19) United States
(12) Patent Application Publication
(10) Pub. No.: US 2026/0316185 A1
(43) Pub. Date: Oct. 15, 2026

(54) LASER WELDING METHOD AND WELDING SYSTEM FOR VEHICLE PARTS MADE OF ALUMINUM-SILICON COATED HOT PRESS-FORMING STEEL

(71) Applicant: TRUMPF (China) Co., Ltd., Suzhou (CN)

(72) Inventors: Yuan LIU, Suzhou (CN); Peng ZHUO, Suzhou (CN); Weiyu WANG, Suzhou (CN); Franz LEHLEUTER, Suzhou (CN)

(21) Appl. No.: 19/708,985

(22) Filed: Jun. 16, 2026

Related U.S. Application Data
(63) Continuation of application No. PCT/CN2024/141039, filed on Dec. 20, 2024.

(30) Foreign Application Priority Data
Dec. 22, 2023 (CN) 202311781710.8

(51) Int. Cl. B23K 26/322; B23K 26/082; B23K 26/244; B23K 101/34; B23K 103/04

(52) U.S. Cl. CPC B23K 26/322; B23K 26/082; B23K 26/244; B23K 2101/34; B23K 2103/04

(57) ABSTRACT

A laser welding method for welding vehicle parts made of aluminum-silicon coated hot press-forming steel includes welding along a predetermined continuously winding welding path to form a continuous weld seam. The continuous weld seam forms a block welding area. During welding of at least one section on the welding path, the welding includes preheating the at least one section before laser scanning welding to reduce adverse effects of an aluminum-silicon coating on a weld quality, performing the laser scanning welding on the at least one section, and post-heating an affected zone of the laser scanning welding in step S2 after the laser scanning welding.

### CROSS REFERENCE TO RELATED APPLICATIONS

This application is a continuation of International Application No. PCT/CN 2024/141039 (WO 2025/131076A1 ), filed on Dec. 20, 2024, and claims benefit to Chinese Patent Application No. CN 202311781710.8, filed on Dec. 22, 2023. The aforementioned applications are hereby incorporated by reference herein.

### FIELD

Embodiments of the present disclosure relate to the technical field of laser welding of important load-bearing parts of a vehicle, in particular aluminum-silicon coated hot press-forming steel of a B-pillar, and specifically relates to a laser welding method for welding vehicle parts made of aluminum-silicon coated hot press-forming steel and a corresponding laser welding system.

### BACKGROUND

The A-pillar, B-pillar and C-pillar are important components of a passenger cabin of a unitary construction body and are also the main load-bearing parts of the vehicle, so they have to meet extremely high standards. With the increasing attention paid to vehicle safety, currently the pillars of the vehicle, in particular the B-pillar, are usually made of ultra-high-strength hot press-forming steel. The use of ultra-high-strength hot press-forming steel can also greatly reduce the weight of the vehicle.

Hot press-forming steel has the risk of forming oxide scales during the hot press-forming process, so hot press-forming steel usually contains an aluminum-silicon (Al—Si) coating. The coating forms a continuous, uniform and dense aluminum oxide and silicon oxide protective film on the surface under high-temperature oxidation environments. Compared with other types of coatings, the aluminum-silicon coating can withstand high temperatures and still maintain the shape and performance of the coating in a high-temperature environment of 950° C.

However, this type of coating is very disadvantageous for welding, since the aluminum-silicon coating, for one thing, will melt and enter weld seams during the welding process, causing segregation of the Al element in the weld seams, which will severely reduce the mechanical properties of the welded parts. For another, if a special method is introduced to remove the aluminum-silicon coating at the weld seams before welding, it will greatly affect the welding efficiency.

At present, resistance spot welding is widely adopted for B-pillar welding. However, resistance spot welding is a contact welding process with low efficiency and also problems such as poor contact. In addition, the existing welding methods also face problems such as severe weld spatter and weld cracks.

For the above reasons, corresponding improvements are needed.

### SUMMARY

Embodiments of the present invention provide a laser welding method for welding vehicle parts made of aluminum-silicon coated hot press-forming steel. The laser welding method includes welding along a predetermined continuously winding welding path to form a continuous weld seam. The continuous weld seam forms a block welding area. During welding of at least one section on the welding path, the welding includes preheating the at least one section before laser scanning welding to reduce adverse effects of an aluminum-silicon coating on a weld quality, performing the laser scanning welding on the at least one section, and post-heating an affected zone of the laser scanning welding in step S2 after the laser scanning welding.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a diagram of basic principles of a laser welding system according to an exemplary embodiment;

FIG. 2 shows a top view of a pattern of a welding path according to an exemplary embodiment;

FIG. 3 shows a plurality of block welding areas formed on a first workpiece according to an exemplary embodiment; and

FIG. 4 shows a flow chart of a laser welding method according to an exemplary embodiment.

### DETAILED DESCRIPTION

In order to overcome one of the above disadvantages and/or other possible disadvantages in the prior art not mentioned here, embodiments of the present disclosure provide an improved laser welding method for welding vehicle parts made of aluminum-silicon coated hot press-forming steel and a corresponding laser welding system.

According to a first aspect of the present disclosure, there is provided a laser welding method for welding vehicle parts made of aluminum-silicon coated hot press-forming steel, which laser welding method comprises: welding along a predetermined continuously winding welding path to form a continuous weld seam, and the continuous weld seam forms a block welding area. During welding of at least one section on the welding path, the laser welding method at least comprises the following steps: step S1: preheating the section before laser scanning welding to reduce adverse effects of an aluminum-silicon coating on the weld quality; step S2: performing laser scanning welding on the section; and step S3: post-heating an affected zone of laser scanning welding in step S2 after the laser scanning welding.

According to an optional embodiment of the present disclosure, the welding path extends smoothly.

According to an optional embodiment of the present disclosure, a welding start point of the welding path is arranged closer to a center of the block welding area than a welding end point.

According to an optional embodiment of the present disclosure, the welding path is in a spiral shape.

According to an optional embodiment of the present disclosure, for the same one section, a laser power density during a preheating stage before the laser scanning welding and/or a post heating stage after the laser scanning welding is lower than that during the stage of laser scanning welding.

According to an optional embodiment of the present disclosure, a continuous laser scanning welding process is performed over the entire welding path.

According to an optional embodiment of the present disclosure, one and the same laser head free from the need for adjustment by a beam shaping device is used to perform steps S1, S2 and S3.

According to an optional embodiment of the present disclosure, during steps S1, S2 and S3, a defocus amount of the laser head relative to a workpiece being processed is changed in order to change the laser power density.

According to an optional embodiment of the present disclosure, the laser welding method uses a concentric ring 2-in-1 fiber, which has a ratio of core fiber laser energy to total laser energy preferably in the range of 60%-70%.

According to an optional embodiment of the present disclosure, a laser scanning speed during step S1 is greater than twice the laser scanning speed in steps S2 and S3.

According to an optional embodiment of the present disclosure, the laser head is in a negative focus state during steps S1 and S2, and is in a positive focus state during step S3, and preferably a focal position in the negative focus state is one fifth of that in the positive focus state.

According to an optional embodiment of the present disclosure, one and the same laser head is used to perform a continuous laser scanning welding process over the entire welding path.

According to an optional embodiment of the present disclosure, a continuous laser scanning welding process is performed using an intelligent 3D scanning welding galvanometer.

According to an optional embodiment of the present disclosure, a continuous laser scanning welding process is performed using a laser remote on-the-fly welding technology.

According to a second aspect of the present disclosure, provided is a laser welding system, which comprises: a laser head, and a controller which is configured to control the laser head to perform the laser welding method according to any of the above embodiments.

According to an optional embodiment of the present disclosure, the laser head is configured as an intelligent 3D scanning welding galvanometer.

According to an optional embodiment of the present disclosure, the laser welding system further comprises: a motion mechanism, on which the laser head is arranged and is thus movable under the control of the motion mechanism.

According to an optional embodiment of the present disclosure, the motion mechanism is a multi-axis robot arm or a multi-axis motion mechanism of a machine tool.

According to an optional embodiment of the present disclosure, the controller controls the laser head and the motion mechanism in a coordinated manner.

According to some embodiments of the present disclosure, welding can be performed efficiently and with high quality. The coordination of the three passes can ensure not only the quality of weld seams, but also the mechanical performance of welding areas, laying a solid foundation for the subsequent processing of parts.

The disclosure will be described below in greater detail in conjunction with the drawings and a number of exemplary embodiments. For the sake of clarity, the drawings are not necessarily drawn to scale.

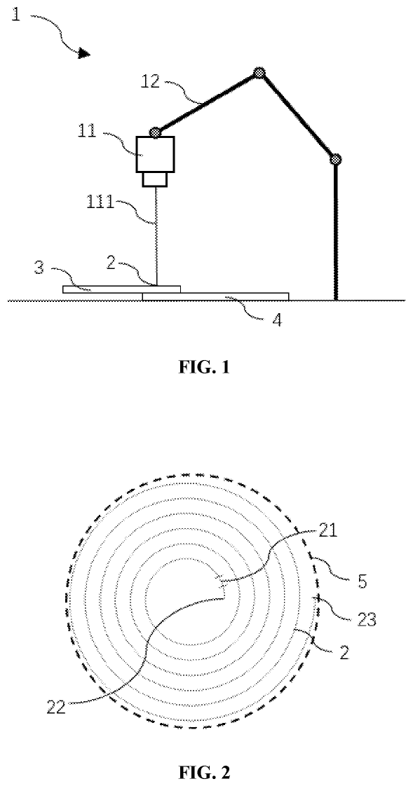

FIG. 1 schematically shows a diagram of basic principles of a laser welding system according to an exemplary embodiment.

As shown in FIG. 1, a laser welding system 1 comprises a laser head 11 and a motion mechanism 12, and the laser head 11 is arranged on the motion mechanism 12 and is thus movable under the control of the motion mechanism 12 in order to weld a first workpiece 3 and a second workpiece 4 along a predetermined welding path 2 to connect the two together. As shown in FIG. 1, the first workpiece 3 and the second workpiece 4 are overlapped on top of each other, so lap welding is used.

The laser welding system 1 can be used to weld vehicle parts made of aluminum-silicon coated hot press-forming steel. The vehicle parts are particularly an A-pillar, B-pillar or C-pillar of the vehicle, more particularly the B-pillar.

FIG. 2 shows a top view of a pattern of a welding path 2 according to an exemplary embodiment. It should be pointed out that the so-called “welding path” refers to the path that is finally formed on the first workpiece 3 by a laser beam 111, along which the weld seam follows, and it does not necessarily refer to the path scanned by the laser beam 111 in chronological order.

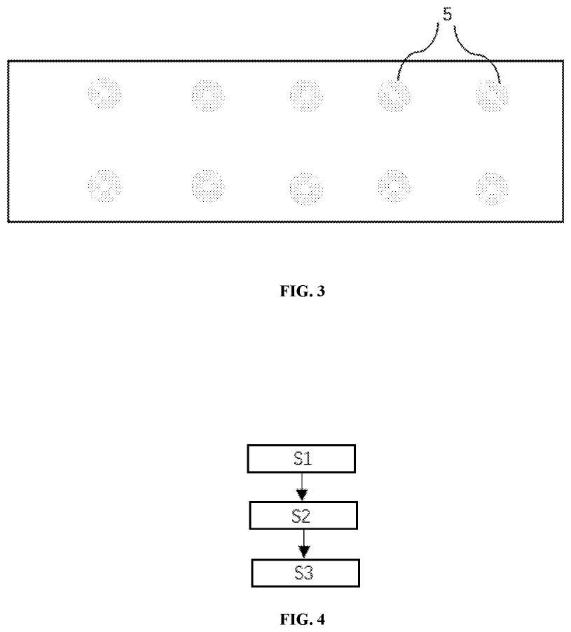

According to one aspect of the present disclosure, there is provided a laser welding method for welding vehicle parts made of aluminum-silicon coated hot press-forming steel, which comprises: welding along a predetermined continuously winding welding path 2 to form a continuous weld seam, wherein the continuous weld seam finally forms a block welding area 5. FIG. 3 shows a plurality of block welding areas 5 formed on the first workpiece 3 according to an exemplary embodiment.

Therefore, in the present disclosure, while the weld seam is a continuous weld seam for a single block welding area 5, the entire first workpiece 3 may contain a plurality of such block welding areas 5 in particular separated from one another, so the weld seams between individual block welding areas 5 may not be continuous. Each of the block welding areas 5 provides material bonding in the corresponding area.

It should also be pointed out here that the “block welding area” refers to a welding area formed by welding along a winding continuous welding path 2 and in the shape of a “block” as a whole, and its boundary can be defined by the outermost weld seam. Within a block welding area 5, the area may be finally fused together into a “large molten pool” due to the dense distribution of the welding path 2.

Just for ease of understanding, the boundary of such a block welding area is shown schematically by a dashed line in FIG. 2.

According to an exemplary embodiment, during welding of at least one section 21 (which is marked by two short dashed lines in FIG. 2) on the welding path 2, as shown in FIG. 4, the laser welding method at least comprises the following steps:
step S1: preheating the section 21 before laser scanning welding to reduce adverse effects of an aluminum-silicon coating on the weld quality;
step S2: performing laser scanning welding on the section 21; and
step S3: post-heating an affected zone of laser scanning welding in step S2 after the laser scanning welding.

A skilled person in the art can understand that although the main purpose of steps S1 and S3 is not to form a molten pool to perform the actual welding, they should still be regarded as part of the entire welding process.

For this reason, the weld seam on each section of the welding path may be welded through multiple passes (three passes here, but in principle other additional processing operations are not excluded). The preheating before welding in step S1 can reduce the adverse effects of the aluminum-silicon coating on the quality of the weld seam. Specifically, it can reduce the possibility of spatter and the formation of a molten pool in step S2 caused by the mixing of Al or Si. Preheating before welding can also slow down the cooling rate of welded parts, avoid the formation of quench hardened structures and reduce welding stress and deformation, and it is also an effective way to prevent weld cracks.

In step S3, the affected zone of laser scanning welding is also heated after welding. The so-called “affected zone” refers to the area that can be affected by the laser scanning beam in step S2, including the area directly acted on by the laser beam and the area affected by the heat of the laser beam. Post-heating after welding can improve the appearance of the weld seam, reduce the residual stress in the welded part, and thus reduce the tendency of crack formation.

The “three-pass” welding is a technical means taking into full consideration the material properties and mechanical properties of aluminum-silicon coated hot press-forming steel, which is also closely related to the specific requirements of vehicle parts made of aluminum-silicon coated hot press-forming steel.

Preferably, for the three-pass welding operation of the section 21, the irradiation of laser beam is continuous, which is an advantage of scanning welding, since it can greatly reduce the process steps of repositioning components such as the motion mechanism and improve welding efficiency.

As shown in FIG. 2, as the welding path 2 is long, it can be divided into multiple sections 21 for welding, and each of the sections 21 is welded by the aforementioned three-pass operation. The irradiation of laser beam is also continuous between any two adjacent sections 21. In this way, the time for positioning the motion mechanism 12 during frequent start and stop, positioning errors, and the pitch time during production can be greatly reduced.

Certainly, a skilled person in the art can understand that, in principle, if the welding path 2 is short and only includes one section 21, it means that the welding operation of each pass is performed over the entire welding path 2.

As shown in FIG. 2, the welding path 2 preferably extends smoothly without any sharp turning points, which is very advantageous to laser scanning welding and also helpful in improving welding efficiency.

According to an exemplary embodiment, a welding start point 22 of the welding path 2 is arranged closer to a center of the block welding area 5 than a welding end point 23. Specifically, as shown in FIG. 2, welding is performed from an innermost end point of the welding path 2 as the welding start point 22, all the way to an outermost end point where the laser beam converges. This method can significantly improve the heat distribution during the welding process and is very beneficial.

According to an exemplary embodiment, as shown in FIG. 2, the welding path 2 is in a spiral shape. This shape has no sharp turning points, which facilitates the efficient implementation of laser scanning welding, and the heat distribution during the welding process is also very beneficial.

Particularly for the welding of aluminum-silicon coated hot press-forming steel of the B-pillar of the vehicle, it is usually desired that the block welding area 5 is roughly circular. The block welding area 5 shown by a dashed line in FIG. 2 is close to a circle; thus, the use of a spiral welding path can also meet this requirement.

As mentioned above, the main purpose of preheating before welding and post-heating after welding is different from the purpose of the laser welding operation in step S2, and a large laser power density like that is not required. Therefore, according to an exemplary embodiment, for the same one section 21, the laser power density during a preheating stage before the laser scanning welding and/or a post heating stage after the laser scanning welding is lower than that during the stage of laser scanning welding.

The laser power density can be adjusted by changing a distance of the laser head 11 (for example, the motor can be regulated to change a defocus amount, i.e., the distance from a focal position to a working surface) relative to a laser beam action area on the workpiece, thereby adjusting a size of a light spot. Certainly, this in principle can also be achieved by adjusting the output power of the laser. Therefore, even if there are three passes of welding operation on each of the sections 21, continuous scanning welding can still be easily performed over the entire welding path 2.

As mentioned above, although the laser power density required for the three passes of welding are different, it can be achieved simply by adjusting the distance of the laser head 11 relative to the laser beam action area on the workpiece, freeing the laser head 11 from the need of a beam shaping device to shape and regulate the laser beam, which means that there is no need to optically shape the laser beam. Hence, according to an exemplary embodiment, one and the same laser head 11 free from the need for adjustment by a beam shaping device is used to perform steps S1, S2 and S3. Thus, a standard laser head can be used.

According to an exemplary embodiment, the laser welding method may use a concentric ring 2-in-1 fiber, a patented technology of the present applicant, which has a ratio of core fiber laser energy to total laser energy preferably in the range of 60%-70%. The ring core fiber can reduce spatter.

According to an exemplary embodiment, a laser scanning speed during step S1 is greater than twice the laser scanning speed in steps S2 and S3. This is because step S1 is the preheating operation before welding, and the scanning can be speeded up.

According to an exemplary embodiment, the laser head 11 is in a negative focus state during steps S1 and S2, and is in a positive focus state during step S3, and preferably a focal position in the negative focus state is one fifth of that in the positive focus state.

As described above, it is very advantageous to allow the use of the same one laser head 11 to perform the laser welding process over the entire welding path 2.

According to an exemplary embodiment, the laser head 11 may be an intelligent 3D scanning welding galvanometer. The intelligent 3D scanning welding galvanometer can greatly improve welding efficiency, especially for welding of complex structures.

As a further exemplary embodiment, the laser welding process may be performed using a laser remote on-the-fly welding technology.

The laser remote on-the-fly welding technology can also optimize the welding process, mainly including the optimization of the welding pattern and welding process.

The use of a PFO scanning galvanometer can realize welding of weld seams in any editable shape and size. In order to optimize welding strength and achieve lightweight, various suitable shapes and sizes of weld seams, and flexible weld distributions and directions of weld seams can be chosen for specific vehicle parts. In addition to flexible and diverse welding shapes, the laser welding can also adopt single-sided welding, which, compared with the resistance spot welding method, can achieve the same welding strength on the inner side of the workpiece that cannot be easily reached, and the welding cost can be reduced.

With regard to the optimization of the welding process, parameters of the welding process can be recorded in real time during remote on-the-fly welding and displayed in the form of a chart. This helps operators quickly find optimizable parameters according to specific vehicle parts, so that the acceleration/deceleration of the motion mechanism can be minimized and the welding cycle time can be shortened, if allowed by the workpiece processing.

According to a second aspect of the present disclosure, there is provided a laser welding system 1, comprising: a laser head 11, and a controller (not shown) which is configured to control the laser head to perform the laser welding method according to any of the above embodiments.

According to an exemplary embodiment, the motion mechanism 12 may be a multi-axis robot arm. As another possible embodiment, the motion mechanism 12 may also be a corresponding multi-axis motion mechanism on a machine tool. In this case, the machine tool may be referred to as a multi-axis machine tool.

According to an exemplary embodiment, the controller can control the laser head 11 and the motion mechanism 12 in a coordinated manner to optimize the welding process and thereby improve welding efficiency.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser welding method for welding vehicle parts made of aluminum-silicon coated hot press-forming steel, the laser welding method comprising:
welding along a predetermined continuously winding welding path to form a continuous weld seam, the continuous weld seam forming a block welding area,
wherein during welding of at least one section on the welding path, the welding comprises:
S1: preheating the at least one section before laser scanning welding to reduce adverse effects of an aluminum-silicon coating on a weld quality;
S2: performing the laser scanning welding on the at least one section; and
S3: post-heating an affected zone of the laser scanning welding in step S2 after the laser scanning welding.

2. The laser welding method according to claim 1, wherein the welding path extends in a spiral shape.

3. The laser welding method according to claim 1, wherein a welding start point of the welding path is arranged closer to a center of the block welding area than a welding end point.

4. The laser welding method according to claim 2, wherein a welding start point of the welding path is arranged closer to a center of the block welding area than a welding end point.

5. The laser welding method according to claim 1, wherein for the at least one section, a laser power density during the preheating before the laser scanning welding and/or the post-heating after the laser scanning welding is lower than that during the laser scanning welding.

6. The laser welding method according to claim 2, wherein for the at least one section, a laser power density during the preheating before the laser scanning welding and/or the post-heating after the laser scanning welding is lower than that during the laser scanning welding.

7. The laser welding method according to claim 1, wherein the laser scanning welding is performed over an entirety of the welding path.

8. The laser welding method according to claim 1, wherein a same laser head free from a need for adjustment by a beam shaping device is used to perform the steps S1, S2 and S3.

9. The laser welding method according to claim 1, wherein during the steps S1, S2 and S3, a defocus amount of a laser head relative to a workpiece being processed is changed in order to change a laser power density.

10. The laser welding method according to claim 1, wherein a concentric ring 2-in-1 fiber is used in the laser welding method, and wherein a ratio of a core fiber laser energy to a total laser energy is in a range of 60%-70%.

11. The laser welding method according to claim 1, wherein a laser scanning speed during the step S1 is greater than twice a laser scanning speed in the steps S2 and S3.

12. The laser welding method according to claim 1, wherein a laser head is in a negative focus state during the steps S1 and S2, and is in a positive focus state during the step S3.

13. The laser welding method according to claim 1, wherein a same laser head is used to perform the laser scanning welding over an entirety of the welding path.

14. The laser welding method according to claim 1, wherein the laser scanning welding is performed using an intelligent 3D scanning welding galvanometer.

15. The laser welding method according to claim 1, wherein the laser scanning welding is performed using a laser remote on-the-fly welding technology.

16. A laser welding system, comprising:
a laser head; and
a controller configured to control the laser head to perform the laser welding method according to claim 1.

17. The laser welding system according to claim 16, wherein the laser head is configured as an intelligent 3D scanning welding galvanometer.

18. The laser welding system according to claim 16, further comprising:
a motion mechanism, on which the laser head is arranged and is thus movable under via the motion mechanism.

19. The laser welding system according to claim 18, wherein the motion mechanism comprises a multi-axis robot arm or a multi-axis motion mechanism of a machine tool.

20. The laser welding system according to claim 18, wherein the controller controls the laser head and the motion mechanism in a coordinated manner.
